(19) United States
(12) Patent Application Publication
(10) Pub. No.: US 2023/0289381 A1
(43) Pub. Date: Sep. 14, 2023

(54) DERIVING LEADING INDICATORS OF ECONOMIC ACTIVITY USING PREDICTIVE ANALYTICS APPLIED TO AGRICULTURAL, MINING, CONSTRUCTION, AND ENVIRONMENTAL ATTRIBUTES TO PREDICT ECOLOGICAL TRENDS AND ECONOMIC OUTCOMES

(71) Applicant: Brian McCarson, Chandler, AZ (US)

(72) Inventor: Brian McCarson, Chandler, AZ (US)

(21) Appl. No.: 18/183,533

(22) Filed: Mar. 14, 2023

Related U.S. Application Data
(63) Continuation-in-part of application No. 17/840,390, filed on Jun. 14, 2022.
Application No. 17/840,390 is a continuation of application No. 16/797,640, filed on Feb. 21, 2020, now Pat. No. 11,361,202.

(51) Int. Cl. G06F 16/587; G08G 3/00; G06F 16/907; G08G 1/01; G08G 5/00; G06N 3/08; G06V 20/13; G06F 18/20; G06F 18/2133; G06F 18/2415; G06N 7/01; G06V 10/764; G06V 10/84; G06V 20/10

(52) U.S. Cl. CPC G06F 16/587; G08G 3/00; G06F 16/907; G08G 1/0133; G08G 5/0004; G06N 3/08; G06V 20/13; G06F 18/29; G06F 18/2133; G06F 18/24155; G06N 7/01; G06V 10/764; G06V 10/84; G06V 20/188

(57) ABSTRACT

Predictive analytics techniques are provided to produce leading indicators of economic activity based on agricultural, fishing, mining, lumber harvesting, environmental, or ecological attributes and other factors determined from a range of available data sources. A consistent, semantic metadata structure is described as well as a hypothesis generating and testing system capable of generating predictive analytics models in a non-supervised or partially supervised mode.

### CROSS-REFERENCE TO RELATED APPLICATIONS

The present invention is a continuation-in-part of U.S. patent application Ser. No. 17/840,390, titled SYSTEM AND METHODS FOR DERIVING LEADING INDICATORS OF ECONOMIC ACTIVITY USING PREDICTIVE ANALYTICS, filed Jun. 14, 2022, which is a continuation of U.S. patent application Ser. No. 16/797,640, now issued U.S. Pat. No. 11,361,202, titled SYSTEMS AND METHODS FOR DERIVING LEADING INDICATORS OF FUTURE MANUFACTURING, PRODUCTION, AND CONSUMPTIONS OF GOODS AND SERVICES, filed Feb. 21, 2020, the entire contents of which are hereby incorporated by reference.

### TECHNICAL FIELD

The present invention relates, generally, to systems and methods for modeling complex economic and commercial systems and, more particularly, to the application of predictive analytics and machine learning, deep learning, active learning and other artificial intelligence techniques to the prediction of future economic or ecological performance based primarily on observations of ecological, agricultural, aquacultural, fishing, construction, mining, deforesting, harvesting, ranching or general environmental attributes observed in the open natural environment, farmland, rural and urban areas.

### BACKGROUND

Historically, the prediction of future economic activity has been based on lagging indicators, such as historical trends in retail sales, industrial production, average prime interest rates, unemployment levels, wage growth, interest rates, inflation rates, monthly housing starts, broadband internet penetration, crop planting and yield reports, lumber harvesting, agriculture or aquaculture activity, mining activity, construction activity and similar economic metrics. These indices are important tools to a wide range of individuals and financial institutions, particularly securities traders, fund managers, government regulators, land management specialists, water management rights managers, farmers, agricultural equipment manufacturers, ranchers, businesses, chemical suppliers, environmental scientists and the like.

Currently known methods for predicting economic activity and associated metrics are unsatisfactory in a number of respects, in part because they rely on intuition, heuristics, publicly available documents (e.g., aggregated quarterly reports for a sector), and/or “technical analysis” of numerical trend data. Trades, positions, and other investment decisions are often based on real time inferences drawn from these indices. High asset value fund managers know that beating a forecast by even a fraction of a percentage point—or receiving pertinent information just seconds earlier than a manager of a competing fund—can instantly result in billions of dollars gained (or lost). Thus, fund managers relentlessly seek real-time “hints” to incrementally sharpen their vision of future economic performance. Environmental regulators, water rights managers, forest managers all would benefit from receiving qualitative information regarding reservoir water level changes, lumber harvesting patterns, spread of diseased trees in a forest, changes in roadway usage, construction patterns, volume of earth moved for mining activities, among other types of information.

More generally, the complexity of unstable market forces, combined with the not-always-rational behavior of its participants, suggests that no single factor can reliably predict future performance, even within a discrete market sector. Rather, multiple factors often coalesce within a fire hose of disparate data streams and datasets, rendering them beyond the grasp of even the most astute financial scholars. Indeed, one estimate suggests that, by the year 2025, global data production will exceed 460 exabytes (1018 bytes) per day. It is simply not possible for human beings to perform traditional hypothesis testing on data of these magnitudes.

Thus, there is a long-felt need for improved methods of identifying, collecting, synthesizing, and processing groups of data to correctly predict the value and/or state of variables which characterize future economic activity or behavior, as well as for improved ways of discovering, vetting, testing, and quantifying the correlations among the factors upon which predictive models are built.

### SUMMARY OF THE INVENTION

Various embodiments of the present invention relate to systems and methods for, inter alia: i) using observed agricultural or aquacultural attributes (e.g., agricultural or aquacultural activities, appearance and behavior in response to both human, machine, development, planting, growth, harvesting, weather, ecological or other environmental variables) ii) using observed ecological or environmental attributes (e.g., reservoir water level, flooding, dredging, drought, forest clearing, lumber harvesting, produce harvesting, surface mining levels, construction activity, river width and depth, snow cap volumes) as factors for predicting future levels of crop production, mining activity, lumber production, population and health of animal herds, utilization of natural or human-made water sources among other activities; iii) identifying and characterizing correlations among the agricultural, aquacultural, lumber harvesting, mining or other ecological-centric factors; iv) identifying and harnessing sources of such data to facilitate quantitative analysis of the factors; v) applying predictive analytics techniques to the factors, the correlations among the factors, the data streams and datasets associated with the factors, the quantitative analysis of the data and the correlations among datasets; vi) using information derived from the application of predictive analytics to yield potential leading indicators of agricultural, ecological, mining, construction or other economic activity based on the environmental, agricultural or ecological-centric datasets selected from a range of available data sources; vii) generating and testing hypotheses utilizing machine learning, deep learning, active learning and/or other artificial intelligence techniques; and viii) applying supervised and/or non-supervised learning techniques in the context of a hypothesis generating and testing system to recursively refine datasets and known correlations among them, identify new data sources, identify or refine new correlations, develop or refine existing analytic and predictive models.

### BRIEF DESCRIPTION OF THE DRAWING FIGURES

The present invention will hereinafter be described in conjunction with the appended drawing figures, wherein like numerals denote like elements, and:

FIG. 1 is a conceptual block diagram illustrating predictive analytics system in accordance with various embodiments;

FIG. 2 is a conceptual block diagram and process flow for a predictive analytics system in accordance with various embodiments;

FIGS. 3, 4A, and 4B illustrate example marine port environments seen in aerial view.

FIG. 5 illustrates an example farm environment seen in aerial view;

FIG. 6 illustrates an example lumber harvesting environment seen in aerial view;

FIG. 7 is a flowchart illustrating a method in accordance with various embodiments; and

FIG. 8 is a conceptual block diagram of a hypothesis generation and testing system (HGTS) in accordance with various embodiments.

### DETAILED DESCRIPTION

The present disclosure relates to improved techniques for identifying and quantifying leading indicators of future levels of agricultural, aquacultural, harvesting, processing, manufacturing, production, and consumption of goods and services, and to machine learning systems and methods for predicting economic or ecological activity and producing actionable leading indicators of that activity.

Furthermore, the present subject matter presents a generative artificial intelligence methodology in the form of a generalized hypothesis generating and testing system that may be employed for the purposes of generating such leading indicators. In addition, the present subject matter describes methods by which users may subscribe to proprietary services to gain access to the indicators. In that regard, the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to economic indicators, securities trading, market activity, machine learning models, and data analytics techniques may not be described in detail herein.

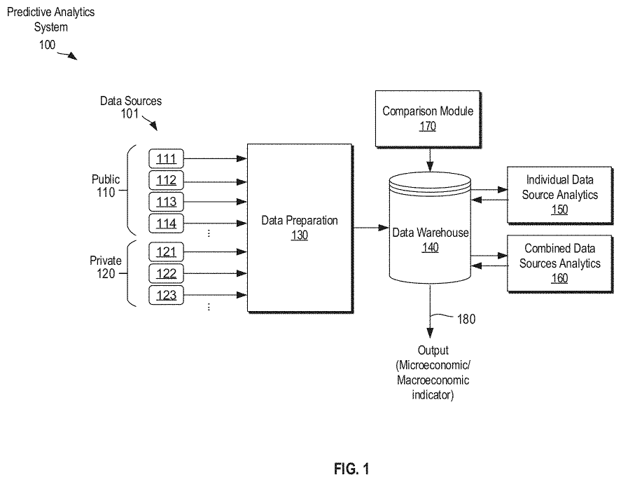

Referring first to the conceptual block diagram of FIG. 1, various embodiments may be implemented in the context of a predictive analytics system (“PAS”) 100. As illustrated, PAS 100 includes a data preparation module 130 configured to receive data from a wide range of data sources 101 (e.g., 111-123), some of which might be public (110) as described in more detail below, and others that that might be private (120). Data preparation module 130 is generally configured to clean and otherwise process the data received from data sources 101 and subsequently store the processed data in a data warehouse 140. Two analytics modules (150, 160) and a comparison module 170 interact with data warehouse 140 in order to produce, using the factors and predictor variables derived from data sources 101, an output 180 which, as described in further detail below, corresponds to a target variable corresponding to an ecological, environmental, agricultural, aquacultural, construction, mining, microeconomic and/or macroeconomic leading indicator.

Data Sources

As a preliminary matter, it will be understood that the data received from data sources 101 may take a variety of forms and may exhibit or embody one or more of a wide range of attributes. Thus, for example, the data will often take the form of discrete or continuous numerical data (e.g., integers, floating point numbers, etc.) or categorical data (e.g., unordered or ordered categories). The data may be provided, for example, as a series of time-varying scalar values, as matrices or tables, as an arbitrary tensor of a given dimensionality, or any other form now known or later developed. Data sources 101 and the datasets derived therefrom are thus the predictor variables used for producing the associated machine learning model(s). In that regard, the phrase “machine learning model” may be used to refer to a set of individual machine learning models, each having a different type and purpose. For example, a convolutional neural network (CNN) model may be used to perform object detection and classification in a scene, while a separate CNN may be used to determine the speed and/or acceleration of an object in a scene.

In addition to pre-processed summary and descriptive statistics, data sources 101 may represent the output of one or more sensors configured to determine a binary or non-binary value or state of the environment and provide a raw or processed stream of information relating to that environment (or objects within the environment). Non-limiting examples of such sensors include optical cameras (for providing discrete or sequential data frames representing images or video feeds), infrared cameras, LIDAR sensors (producing point-clouds of objects in the environment), SONAR and RADAR sensors, microphones, acoustic mapping sensors, natural language processing systems, vibration or weather-related sensors (temperature, humidity, seismic activity, etc.), proximity sensors, gas detectors, pressure sensors, soil monitoring sensors, water level sensors, crop monitoring sensors, global positioning system sensors, wireless radio sensors, geo-location sensors, and the like.

Data sources 101 may be categorized as either public (110) or private (120). As used herein, public or “open” data sources are those sources of data that are generally available free of charge (or for a nominal fee) to individuals and/or corporate entities, typically in electronic form via the Internet. Such public data sources may be provided, in many instances, by governmental entities, but might also be provided by (or otherwise available from) private companies. In contrast, “private” data sources are those that are fee based, behind a paywall, or otherwise require a form of permission for access. With respect to both public and private data sources, the data itself may be anonymized, pseudonymized, or provided in accordance with a differential privacy (DP) protocol.

Non-limiting examples of public data sources include: (1) social media feeds (e.g., Facebook, Twitter, YouTube, Instagram, Tumblr, Pinterest, Facebook Graph API, LinkedIn, Social Mention, WeChat, Baidu, Google Trends, etc.); (2) mapping and satellite data (Google Maps, Google Earth, MapQuest, Bing Maps, Apple Maps, etc.); (3) municipal street, highway or port of entry traffic, waterway, shipping dock or seaport vessel traffic, airport commercial or passenger aircraft traffic, railway commercial or passenger traffic, pedestrian traffic camera feeds; (4) open datasets relating to global issues, such as the World Health Organization (WHO) Open data repository, Google Public Data Explorer, the European Union Open Data Portal, the U.S. Census Bureau; (5) financially focused open data sources such as the UN Comtrade Database, the International Monetary Fund (IMF) datasets, the U.S. Bureau of Economic Analysis, the U.S. Securities and Exchange Commission, the National Bureau of Economic Research World Bank Open Data; (6) crime data, such as the FBI Uniform Crime Reporting Program, the National Archive of Criminal Justice Data (NACJD); (7) academic datasets, such as Google Scholar, Pew Research Center, National Center for Education Statistics; (8) environmental data, such as Climate Data Online (CDO), National Center for Environmental Health (NCEH), the IEA Atlas of Energy; (9) business directory data, such as Glassdoor, Yelp, LinkedIn, Open Corporates, and the like.

Private data sources may include, for example, Bloomberg, Capital IQ, and Thompson Reuters financial databases, as well as other subscription-based access to audio, video, or image feeds that may be provided by various entities. Additional data feeds might include onboard vehicle camera data sources provided by commercial or passenger vehicle manufacturers or third party or public transportation operators, security camera feeds provided by commercial or residential real estate property owners or their leased business owners. Location and movement tracking information may be derived from global positioning systems, mobile phone or radio tower tracking, retail order or financial banking, credit card, debit card, mobile phone, social media-based, cryptocurrency, purchase or currency exchange transaction information. Private data sources might also include purchase, shipping and receiving tracking information for parcels, goods, services; crop planting, harvesting and yield information; livestock breeding, fishing, herding or other animal production or slaughter information; raw material or refined goods production, storage, sale or trading information such as crude and refined oil or natural gas as well as minerals, lumber, cement or other physical materials; service call records; and equipment utilization or tracking information.

In accordance with edge-computing or cloud-computing principles, video and/or still image data may be processed or analyzed to extract relevant information prior to being provided to data preparation module 130. For example, object detection and classification may be performed on images based on an appropriately trained convolutional neural network (CNN) model, and the resulting classifications and or regression parameters may be stored as metadata, as described in further detail below. In other embodiments, data sources 101 provide raw, unprocessed data that is handled by data preparation module 130.

### Example: Agricultural, Aquaculture, Ranching, Fishing

While the present invention may be utilized in a wide range of data sources, in accordance with one embodiment, system 100 is used to make inferences—and produce an appropriate leading indicator output 180 (e.g., a temporally leading indicator)—based on observations relating to agricultural or aquacultural activity, such as the behavior, patterns, activities of farming equipment; the tilling, growth, volume, color, density, height, yield of planted crops, the response of planted crops to ecological or environmental events, trends in temperature, timing of seasonal changes relative to tilling, planting, fertilizing or harvesting activity and the like. Furthermore, this same methodology could be applied to monitoring of livestock and ranching activity in pastures or open ranges or monitoring the activity and output of fishing vessels, fish hatcheries, fish farming in any type of water body.

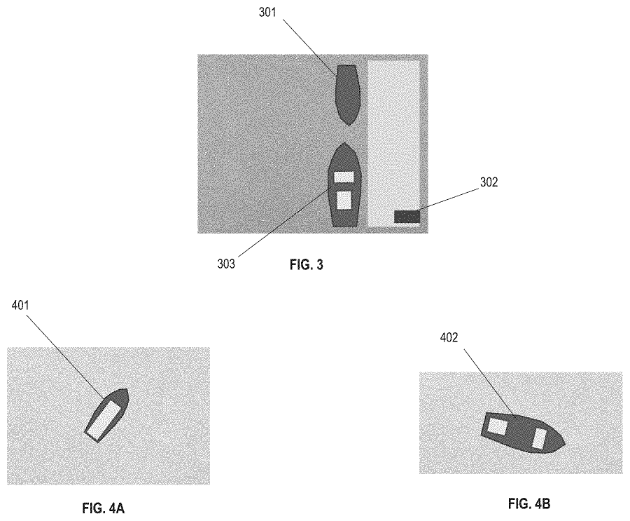

In that regard, FIGS. 3 and 4 depicts an example of marine port environment as seen in aerial view. More particularly, as shown in FIG. 3, two fishing vessel's 301 and 303 are shown located at a port, along with one or more sensors, such as a land-based video camera 302. In FIGS. 4A and 4B, vessels 401 and 402 are seen in open water harvesting fish in different environments.

In one embodiment, for example, various sensors (e.g., 302) are cameras (e.g., a combination of IR and optical cameras) whose positions and orientations give them a view of the approaching vessels. Thus, sensor 302 corresponds to one or more data sources 101 as illustrated in FIG. 1, and may be considered a public data source (e.g., a stationary Internet webcam) or a private data source (e.g., camera access provided for a fee). Sensor 302, when used in conjunction with the predictive analytics system 100, is capable of observing a number of attributes of vessels 301 and 303.

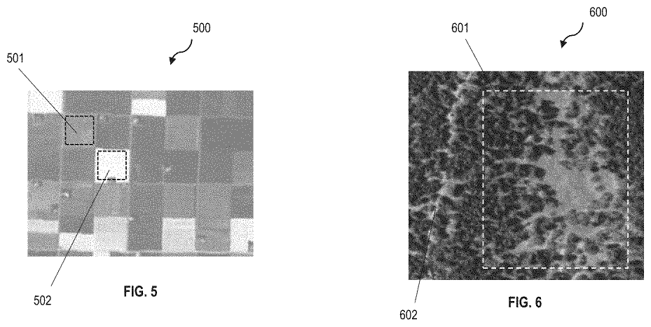

In addition, referring now to FIGS. 5 and 6, sensors may be used to produce images that can be analyzed to determine the number and position of farming vehicles, crop harvesting machines, crop transportation vehicles, lumber harvesting machines, lumber transporting vehicles and the like. Satellite or aerial images can be analyzed either statically or as a series over time to provide an assessment of the production activity on the land and combined with other imaging or sensing sources to provide assessments of the types and health of the agricultural, mines, forested area.

In FIG. 5, for example, two farm regions (501 and 502) are identified within an agricultural environment 500. Various attributes of each region may be determined using appropriate sensors and other available information, such as farm ID, dimensions, location (long./lat.), area, activity log information (e.g., “soybeans planted Feb. 13, 2023”), current status, such as soil moisture, phosphorus level, nitrogen level, luminescence rate, sunlight does, and other metadata such as insect infestation probability, disease log information, crop rotation history, and the like.

Similarly, in FIG. 6, a lumber harvesting region 601 is identified adjacent to a logging road 602 within an environment 600. As with the farm regions shown in FIG. 5, various attributes of each region may be determined using appropriate sensors and other available information, such as region ID, dimensions, location, area, activity log information (e.g., “45% deforested”), logging permit number, current status, such as soil moisture, forest cover, luminescence rate, sunlight dose, and metadata such as insect infestation probability, disease log information, logging vehicle identifiers, and the like.

While not illustrated in the drawings, a further machine learning or deep learning model (e.g., a convolutional neural network) may be used to identify the unique characteristic of a plot or region of land relative to the types and methods of equipment utilized for agricultural purposes, the rotation and timing of crops, timing of irrigation or fertilization, proximity in time to planting, harvesting, watering or fertilizing events relative to ecological or environmental factors can all be tracked over time. Spectral analysis from aerial, satellite, ground images can be used to identify the color of foliage, the size of grazing cattle, the nutrient density in turned soil, the level of moisture in the soil, the density of fruit in an orchard, among many other examples. This activity trending can be used to create custom predictive analytics which can be offered to owners or caretakers of that land, regional governments, farming collectives or coalitions, agricultural manufacturers, fertilizer or seed producers, as a paid subscription or one-time analysis service that is very specific to their precise geography and environmental or regional conditions. Furthermore, one could also track where different plot or regions of land or where specific crops are sent for processing and use this to assess supply/demand trends in advance of potential pricing moves on the market given where agricultural products are being sent, shipped, stored, processed and/or sold. With the aggregation of data as described above, systems in accordance with this invention can predict where regions will see either reduced or increased production in metrics such as crop yields, cattle growth, improved recommendations for crop rotations, planting or harvesting timing or other similar or related events or information that would be influences by environmental or ecological changes and events.

In the case of monitoring fishing vessels, side view images provided by sensors on shore or aerial or satellite images can be used with other available public and private data sources to characterize the activity, behavior and economic output of fishing vessels. For example, the wake region extending from the stern of the vessel may be analyzed from its top view image (as might be available from satellite data). That is, both the dispersion angle θ and wake distance x may be correlated to the amount of water being displaced over time, which will directly correlate to weight and speed of the vessel, which itself relates to the amount of goods being transported pre and post a fishing harvest. Furthermore, given that fishing vessels will have unique identifying features, the travel patterns of specific vessels can be tracked over time and activity from any domestic or international port can be tracked over time to identify precisely which ones are complying with regional or international fishing laws, which vessels are or are not complying with appropriate fishing techniques to prevent ecosystem damage from improper fishing or over fishing. Such information can be shared with businesses, individuals, regional or international government bodies, commodities traders, supply chain managers, educational institutions, among others.

### Example: Water Source Monitoring

In accordance with another embodiment, system 100 may be used to make inferences based on environmental or ecological patterns associated with the natural or human-influenced distribution of water. For example, i) utilizing aerial, satellite or ground-based monitoring of the volume and density of precipitation and/or snowfall that feeds tributaries to creeks, marshes, rivers, lakes or other water sources that could feed municipal, agricultural, rural or urban communities, ii) monitoring the rise and fall of water reservoirs across an entire region over time, iii) monitoring the use of well-based water pumping over time, iv) monitoring the use of pipelines, desalinization facilities, irrigation canals, rivers, or other methods of transporting water to a region, v) tracking public or private information about utilization of water rights, water use licenses, water production or utilization reports and vi) correlating that information to observed weather or ecological trends and events over time.

The resulting information can be compiled and used to create custom predictive analytics which can be offered to owners or caretakers of that land, regional governments, farming collectives or coalitions, water rights management organizations, businesses, individuals, water rights investors as a paid subscription or onetime analysis service that is very specific to their precise geography and environmental or regional conditions.

### Example: Lumber Harvesting or Mining Activity

In accordance with another embodiment, system 100 may be used to make inferences relating to lumber harvesting (as shown in FIG. 6), mining, or other natural resource economic indicators. In such cases, data sources 101 might include, without limitation: (1) satellite images, aerial images, ground based images as they change over time, which can be used to determine changes in i) volume or density of any given forest, jungle, rainforest or other harvestable land area over time to determine the impact and/or health of an ecosystem, or in ii) the volume of earth moved, displaced, mined or transported for the purposes of harvesting natural materials over time to determine the volume of raw materials that are expected to be harvested. The quantity of lumber removed from an area of forest, the volume of trees impacted by forest fires, diseases, droughts, or other environmental factors, etc.; (2) private or publically available information from government agencies re lumber harvesting permits or mining activities by region; (3) public data on regional climate patterns, such as rainfall, freeze temperatures, droughts, flows, snow, fires, and the like; (4) sensing data from individual forest areas, land areas or groups of regions; (5) lumber, rare earth element, coal or any other harvested commodity market prices for local, regional, international markets; (6) road camera images that show transportation of harvested and processed goods over time; (7) satellite imagery illustrating lumber or refined material storage. In accordance with this embodiment, the output 180 may relate to commodity price predictions or any other related raw material indices.

Data Preparation

Referring again to FIG. 1, data preparation module 130 includes any suitable combination of hardware, software, and firmware configured to receive data from data sources 101 and process the data for further analysis by system 100. The processing required by each data source 101 will generally vary widely, depending upon the nature of the data and the use that will be made of the data. Such processing might typically include, for example, data cleaning (e.g., removing, correcting, or imputing data), data transformation (e.g., normalization, attribute selection, discretization), and data reduction (numerosity reduction, dimensionality reduction, etc.). These techniques are well known in the art, and need not be described in further detail herein.

In addition to standard data pre-processing techniques, data preparation module 130 may also assign a consistent form of meta-data to the received data streams. That is, one limitation of prior art data analysis techniques is that data sources 101 are available in a variety of forms. Sometimes the “meaning”, context, or semantic content of the data is clear (e.g., data table fields with descriptive labels), but in other cases the data may not include a data description and/or might include non-intuitive terms of art. Accordingly, one advantage of the present invention is that it provides a consistent metadata structure and syntax used to characterize the data and facilitate future analysis (e.g., using the hypothesis generating and testing program, described below). In one embodiment, this metadata structure is a fundamental and critical enabler of assisted learning and/or unsupervised learning techniques. The metadata may take a variety of forms (e.g., XML, RDF, or the like), and may include any number of descriptive fields (e.g., time, date range, geographical location, number of shipping containers observed, nationality of vessel, sensing system make and model information as well as sensitivity or resolution, analytic methods or model revision information used to perform any cleansing, analysis, etc.).

Comparison Module

Comparison module 170 is generally configured to compare the predictions made via the leading indicator output 180 to the actual, ground-truth values that occur over time. In this way, comparison module 170 assists in validating models as well as signaling to data source analytics modules 160 and 150 that a particular model may need to be further tuned or replaced altogether with a different or more refined version of the model.

In some embodiments, comparison module 170 monitors the predictive power of output 180 and takes an action when the correlation coefficient or other statistical metric of the model falls below some minimum correlation, accuracy, or precision level. That action might include, for example, re-running the model on new data, using a different predictive model, and/or temporarily stopping production of a given output 180. In some embodiments, the hypothesis generating and testing system 800 (described below) may be used to train, validate, and test a new model based on its hypothesis testing results.

Data Source Analytics

Data source analytics modules 150 and 160 include suitable hardware, software, and firmware configured to produce and refine predictive analytic models to be used to produce the leading indicator output 180. That is, modules 150 and 160 take the predictor variables derived from the various data sources (i.e., past data) and build a model for predicting the value of a target value (also based on past, historical data) associated with an economic activity metric. The trained model is then later used to predict, using current or contemporaneous information from the data sources, the future value of that agricultural, mining, fishing, harvesting, water production or any other economic activity metric.

As a preliminary matter, the phrase “predictive analytics” is used in the sense of analytic models that are “forward-facing” and are evaluated based on how well they predict future behavior, rather than “descriptive analytics,” which are primarily “backward-facing” techniques meant to characterize the nature of the data in the simplest way possible. Thus, for example, Occam's razor and descriptive analytics might suggest that a dataset can be fitted in a manner that produces reasonable R² and correlation values using a simple linear regression model, while that model may not be as proficient at actually predicting future values when compared to a heterogeneous ensemble model that combines decision trees, neural networks, and other models into a single predictor or series of predictors.

In accordance with the present invention, data source analytic modules 150 and 160 are implemented as one or more machine learning and deep learning models that undergo supervised, unsupervised, semi-supervised, reinforcement, or assisted learning and perform classification (e.g., binary or multiclass classification), regression, clustering, dimensionality reduction, and/or such tasks.

Examples of the models that may be implemented by modules 150 and 160 include, without limitation, artificial neural networks (ANN) (such as a recurrent neural networks (RNN) and convolutional neural network (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest neighbor, K-means, expectation maximization, hierarchical clustering, etc.), and linear discriminant analysis models. In addition, data sets may be derived using natural language processing (NLP) techniques, such as GPT3 (including, for example, ChatGPT-type interpretation engines), or the like.

In accordance with various embodiments, CNN techniques are applied to those data sources 101 that include imaging, video and/or audio data. In this way, object detection and classification can be performed. For example, publicly available imaging data may be analyzed to determine the number, class, and origin of farm, fishing, mining, lumber harvesting or transport trucks/machines/vessels traveling on a plot or region of land, waterway, roadway, storage or processing facility at a particular time (e.g., Chinese, Japanese, or Chilean origin fishing vessels operating in the South Pacific Ocean and the like). A trained CNN may also be used to observe marine vessels in the vicinity of a port (as described in further detail below) and determine the number and type of offloaded shipping containers. In yet other embodiments, aerial image data of cattle in an open range, lumber harvesting in a national forest, or earth-moving vehicles in an open pit mine may be analyzed to perform object detection and classification of animals, trees, or vehicles over time.

Data Warehouse

Data warehouse 140 is configured to store the various structured and unstructured data generated or otherwise processed by data preparation module 130, comparison module 170, and data source analytics modules 150 and 160. In that regard, data warehouse 140 may be implemented using a variety of known data storage paradigms, including, for example, a relational database management system (RDBMS) such as Oracle, MySQL, Microsoft SQL Server, PostgreSQL, or the like. Data warehouse 140 may also be implemented using NoSQL databases, distributed databases, schema-free systems (e.g., MongoDB), Hadoop, and/or any other data storage paradigm now known or later developed.

Ecological, Environmental, Microeconomic/Macroeconomic Indicators

Output 180 of system 100 may be any indicator or set of indicators that are capable of predicting, alone or in combination with other indicators, the state of a natural or human-influences ecological system, agricultural system, watershed or irrigation system, microeconomic and/or macroeconomic system—for example, a metric that characterizes that space. This system may be global, national, regional, online, or any other subset of environmental, ecological, agricultural, mining, fishing or other economic activity, may take a variety of forms, and may correspond to a wide range of attributes.

As with the data sources described above, output 180 will often take the form of discrete or continuous numerical data (e.g., integers, floating point numbers, etc.) or categorical data (e.g., unordered or ordered categories). Output 180 may include a series of time-varying scalar values, one or more matrices or tables, or higher order tensors of numeric values. Output 180 may also be Boolean (e.g., True/False) or may contain the output of deep learning applied image, video or audio inference.

In general, indicators of ecological, environmental, agricultural, fishing, harvesting or other economic events can be categorized as either leading indicators (which precede future events), lagging indicators (which occur after events), or coincident indicators (which occur at substantially the same time as events). In accordance with the present invention, output 180 is preferably either a leading indicator or, when output 180 can be provided to a subscriber very quickly, a coincident indicator.

The semantic meaning of output 180 may vary depending upon context. In the shipping scenario, for example, output 180 might include the estimated weight of some agricultural or fishing product, such as corn, wheat, tuna, salmon, or the like, harvested from, exported or imported into the country during a certain timeframe. In a lumber harvesting scenario, output 180 might be the number and/types of vehicles Utilized in a region of forest at a set of observed locations. In the context of agricultural products, output 180 might include, for example, the percentage of hemp crops that appear to be unusually dark in aerial view images.

The output 180 might also include information that indicates levels of construction or earth moving activity derived by monitoring construction vehicles, movements of heavy equipment, physical changes to construction sites that is then correlated to government published housing starts information and the published reports from corporations involved in construction to create predictive metrics of building or mining activity. The same techniques could be used to track the rate of lumber harvesting, lumber mill activities, livestock farming, road/bridge/building construction, surface mining or mineral collection, chemical refining processes, loading/shipping/unloading of goods at ports of entry, vehicles being sold from a retail car lot, vehicles in inventory after manufacturing, cargo or passenger trains on an entire railway network, to only name a few. These all can be correlated to historical published or private reports of economic activity to model and ultimately predict economic market trends.

Process Flow

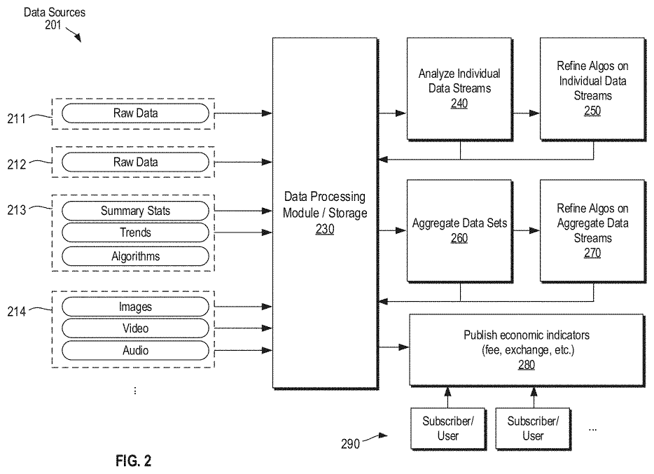

FIG. 2 presents a combination block diagram & flow chart that illustrates, generally, the way information and data may flow through PAS 100 as illustrated in FIG. 1. More particularly, referring now to FIG. 2 in combination with FIG. 1, data sources 201 may include various raw data streams (211, 212) as well as composite data types such as, for example, summary statistics, trends, and algorithms (213), or images, video, and audio streams (214). Data sources 201 in FIG. 2 thus generally correspond to data sources 101 in FIG. 1.

Similarly, data processing and storage module 230 in FIG. 2 generally corresponds to data preparation module 130 and data warehouse 140, and is configured to clean, sort, filter, concatenate, process, and otherwise format the data from data sources 201. Subsequently, individual data streams are analyzed (module 240) and then the various predictive analytics models for those data sources are refined and fed back to module 230 (via module 250). In general, the phrase “dataset” as used herein refers to a portion or subset of data received from a data stream. In parallel, aggregate datasets are analyzed (module 260), refined (module 270) and provided back to module 230 for storage. Thus, modules 240 and 250 together correspond to module 150 in FIG. 1, and modules 260 and 270 generally correspond to module 160 of FIG. 1.

Finally, via a publishing module 280, the various leading indicators (generally corresponding to output 180 in FIG. 1) are provided to a set of subscribers/users 290. The published indicators, data models, predictions, may be provided in exchange for a fee (e.g., a one-time fee or subscription fee), or may be provided in exchange for access to privately owned data sources or other information of value to the process as illustrated.

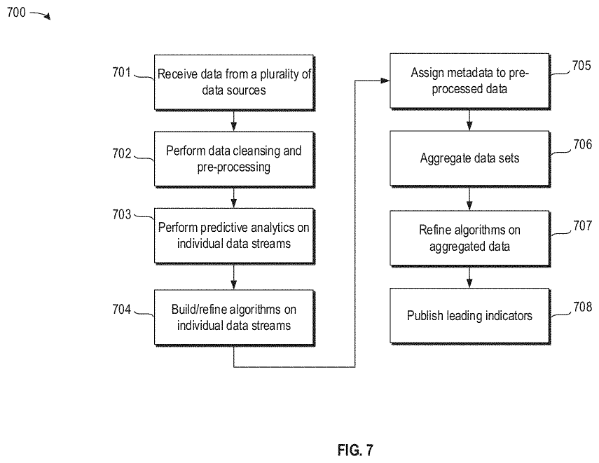

FIG. 7 is a flowchart illustrating a method 700 in accordance with one embodiment of the present invention, and generally corresponds to the major processes illustrated in FIG. 7. More particular, data is first received from a plurality of data sources (step 701), followed by data cleansing and pre-processing (702). Subsequently, predictive analytics are performed on individual data streams (703) and the resulting models and algorithms are refined (704). Metadata may then be assigned to the resulting data (705). The datasets are aggregated (706), and then the predictive analytics models and algorithms for the aggregated data are further refined (707) as previous described. Finally, the leading indicators are published for use (708).

Generalized Hypothesis Generating and Testing System

As mentioned in the Background section above, predictive factors are likely to be buried in a vast array of fast-moving data streams that cannot be analyzed in the traditional manner by human beings—i.e., the time consuming process of applying traditional hypothesis testing and the scientific method to such data by humans is impracticable.

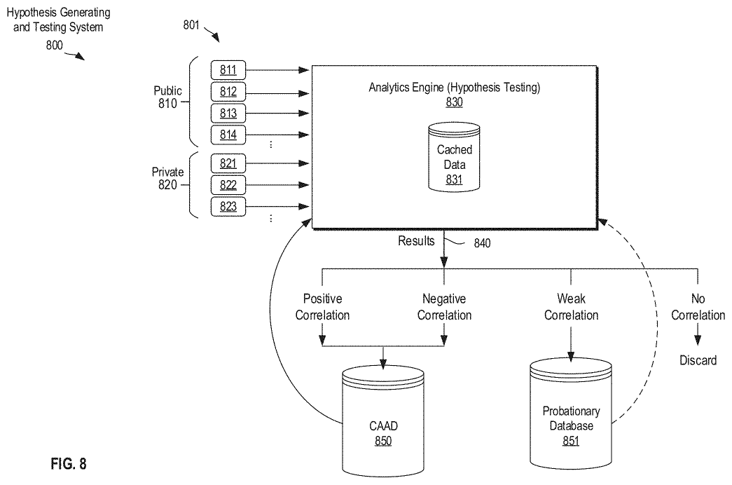

To remedy this, FIG. 8 illustrates a hypothesis generating and testing system (HGTS) 800. In general, HGTS 800 can be seen as a further abstraction of the predictive analytics system 100 of FIG. 1, in that it uses machine learning techniques to teach itself how to form the predictive analytics models described above. Thus, HGTS can be seen as a form of general artificial intelligence operating in the field of ecology, environmental science, agriculture, mining, fishing, forestry or other economic activities.

In general, analytics engine 830 is configured to form its own hypothesis (e.g., “variable 1 is correlated to variables 2 and 3”) and subsequently test that hypothesis on cached data 831 and/or data sources 801. Thus, engine 830 is capable of performing its own planned experiments. The results and conclusions of its experiments (e.g., correlation coefficients, analysis of variance, etc.) are stored along with the hypothesis and model itself in a metadata format so that ongoing trends in model accuracy can be observed and utilized to further improve both model/algorithm accuracy as well as the hypothesis generating and testing system itself.

In order to facilitate the creation of hypotheses, a consistent metadata format is provided. This allows the system to minimize the effort required for unassisted hypothesis generation and testing by properly presenting data for analysis, thus more-effectively “compare apples to apples.” The structure of the metadata may vary, but in one embodiment the metadata includes data format, date range, sensor type, sensor accuracy, sensor precision, data collection methods, location of data collection, data preparation methods performed, image content ranges, NLP methods, data source/publication, and the like.

Referring now to FIG. 8, HGTS 800 generally includes an analytics engine 830 that receives data from data sources 801 (e.g., 811-814 and 821-823), including both public data 810 and private data 820. The nature of this data is the same as previously described in connection with FIGS. 1 and 2. Analytics engine 830 also includes a cached data store 831 for storage of data used in prior experiments.

Engine 830 may begin by performing an initial round of experiments with limited datasets to assess whether a particularly hypothesis is likely to be successful. After initial correlations are found, the engine 830 prioritizes a list of possible hypotheses and seeks to explore those. This is comparable to the separate training, validation, and testing steps used in connection with training machine learning, deep learning, assisted learning or other models.

As is known in the art, a leading indicator may be characterized by its direction relative to the attribute it is being tested against—i.e., procyclical (same direction), countercyclical (opposite direction), or acyclical (no correlation). As illustrated in FIG. 8, after an experiment has concluded, the results (840) inform how the experiment is treated. Specifically, if there is a statistically significant correlation—either positive or negative (i.e., countercyclical or procyclical)—the metadata, model, and data for that experiment are stored in context-aware artificial intelligence database (CAAD) 850. If there is a non-existent correlation (i.e., acyclical), the entire experiment is discarded. If, however, the determined correlation and/or its statistical significance are borderline or otherwise weak, then that experiment may be stored within probationary database 851 for further correlations refinement with additional hypotheses to be tested when additional computation cycles or when additional data become available. This is of critical importance as economic trends are never due entirely to a single factor but rather are a culmination of an extensive set of dependent and independent variables. Thus, as societies change with the advent of new technologies, new geo-political issues, new trade deals, new manufacturing methods, new shipping methods, new laws or policies, new weather patterns, etc. new variables will begin to emerge with greater significance where they previously were irrelevant and vice versa. By storing hypotheses in a probationary database it is possible to trend correlations over time and begin to explore new factors that may be been previously unknown or undervalued in performing economic analyses. This would provide a major advantage for any system of analytics as the prioritization of variables of emerging relevance could become easily identifiable.

The above systems and methods may be used in scenarios where regional epidemics, global pandemics, environmental or ecological changes, newly permitted lands, military or political conflicts, or socioeconomic unrest arise in order to precisely measure the impact in economic activity trends associated with changes in manufacturing, processing, shipping, storage, distribution, and tourism by region, by economic sector and by company. Such information may be a leading indicator used to make more informed investment decisions.

The successful experiments stored within CAAD 850 can then be re-used or incorporated into subsequent experiments by analytics engine 830. Similarly, analytics engine 830 may choose to recall an experiment from probationary database 851 and refine it for further testing—perhaps using a larger or less noisy data set, or changing dependent/independent variables.

### Example: Agricultural, Environmental, and Ecological-Centric Embodiments

In general, the systems and methods described above may be specifically applied to attributes of crops, forests, waterbodies, mining areas, fishing areas and/or the human/equipment behaviors that influence those areas observed in the environment. In such an embodiment, at least one of the plurality of datasets includes first sensor data derived from direct observation of activity within an environment, and the plurality of datasets includes a set of environmental, ecological, agricultural, animal, plant or raw material harvesting attributes.

In this agricultural, fishing, harvesting, mining, ecological, or environmental-centric embodiment, the system includes a predictive analytics module and/or an HGTS, as described above. Specifically, the predictive analytics module is configured to train first and second machine learning models using the datasets as a source of predictor variables based on the assigned metadata for each of the machine learning models, and to use historical information regarding a metric of economic activity as a target variable, wherein the first and second machine learning models differ in at least one of machine learning model type and assigned metadata.

In accordance with one embodiment, the set of agricultural attributes includes (1) earth moving, land preparation, crop planting, crop harvesting, crop rotation, crop transportation, crop storage or crop processing data, (2) agricultural techniques and equipment used including identifying machine appearance data that can be collectively identified as belonging to one or more businesses, or government entities, and (3) connections or correlations to other datasets that contain associated information about identified land, weather patterns, local, regional, national, international data sets pertaining to those crops, weather patterns, events, and regions of production including market prices, supply/demand information, yield, among others.

In accordance with one embodiment, the set of ranching, harvesting, fishing attributes includes (1) animal types, animal quantities, gathering or harvesting methods, types and techniques of transportation to and from the harvesting location, captured animal transportation, animal storage or animal processing data, (2) fishing, ranching, harvesting techniques and equipment used including identifying machine or fishing vessel appearance data that can be collectively identified as belonging to one or more businesses, or government entities and (3) connections or correlations to other datasets that contain associated information about identified land, water body, port or harbor activity, weather patterns, local, regional, national, international data sets pertaining to those lands or water bodies, weather patterns, events, permitting and regulation compliance, and regions of production including market prices, supply/demand information, production or harvesting yield, among others.

In accordance with one embodiment, the set of lumber harvesting or mining activity attributes includes (1) earth moving, land preparation, roadway clearing, tree cutting, tree transportation, mining equipment, mining processing, lumber cutting, raw material transportation, storage or processing data, (2) harvesting or mining techniques and equipment used including identifying machine appearance data that can be traced to individual machines or collectively identified as belonging to one or more businesses, or government entities, and (3) connections or correlations to other datasets that contain associated information about identified land, weather patterns, local, regional, national, international data sets pertaining to permitting and regulation compliance, and regions of production those forests, farms or lands where mining is occurring, weather patterns, events, and regions of production including market prices, supply/demand information, yield, among others.

In accordance with one embodiment, the set of ecological or environmental attributes includes (1) observations of water sources including but not limited to pumping, springs, snow caps, rain forests, ponds, marshes, creeks, or river tributaries that feed into larger water bodies or reservoirs (2) dam, irrigation, flood control, runoff management systems and the trends of behaviors of those systems over time that can be traced to usage or utilization of resources that can from individuals, local or regional governments, farms, ranchers, businesses, land management collectives, or government entities, and (3) connections or correlations to other datasets that contain associated information about identified land, weather patterns, local, regional, national, international data sets pertaining to permitting and regulation compliance, and regions of production of the communities, farms, businesses or government lands that rely upon that resource, construction or earth moving or development events that may impact local or regional ecology, weather events, and regions of production including market prices for the resource, market prices for water rights, supply/demand information, among others.

Furthermore, image analysis may be used by the present system to assess where fishing vessels, vehicles, machines, tractors, harvesting or fertilizing equipment, mining equipment, earth moving equipment and the like is coming from, how far they are traveling, if they are leaving a facility with more or fewer cargo, what type of cargo they are leaving with, fuller or emptier vessels, if more or fewer individuals are working in and around that machine, vehicle or vessel, as well as what type of vehicle they are placing the cargo in as well as uniquely identifying characteristics of the individual machine. This information can be combined, for example, with mobile device network information, geo locationing, WiFi hotspot activity, mobile network tower pings, and triangulation to provide additional insights.

All of the above data, information, and models can be used to help farmers, businesses, governments, environmental specialists, water rights analysts, investors, economists and the like better understand the agricultural, aquacultural, mining, development or environmental conditions, estimate or predict yield and identify opportunities and use this to make more informed investing choices, permitting choices, land and water management choices, ecological choices, etc.

In conclusion, the foregoing describes various systems and methods for applying predictive analytics techniques to produce leading indicators of economic activity based on a range of available data sources, such as farm, fishing, ranching, harvesting, mining, lumber harvesting, water or resource management attributes. In some embodiments, those methods include applying such predictive analytics techniques to produce leading indicators based on public and/or private transportation data, for example, producing the leading indicators based on data sources associated with the direct observation of activity at one or more maritime facilities. In some embodiments, the method includes producing the leading indicators based on aerial view images of consumer vehicles. What has also been described are systems and methods for providing a fee-based subscription system for the sharing of such leading indicators to users. More broadly, the present subject matter also relates to a system for providing a consistent, semantic meta-data structure associated with data and for generating and testing hypotheses utilizing machine learning, deep learning, assisted learning techniques (e.g., via non-supervised learning).

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices.

In addition, those skilled in the art will appreciate that embodiments of the present disclosure may be practiced in conjunction with any number of systems, and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the terms “module” or “controller” refer to any hardware, software, firmware, electronic control component, processing logic, and/or processor device, individually or in any combination, including without limitation: application specific integrated circuits (ASICs), field programmable gate-arrays (FPGAs), dedicated neural network devices (e.g., Google Tensor Processing Units), quantum computing, visual or image processing units, graphic processing units (GPUs), system on chips (SOCs), central processing units (CPUs), microcontroller units (MCUs), electronic circuits, processors (shared, dedicated, or group) configured to execute one or more software or firmware programs, a combinational logic circuit, and/or other suitable components that provide the described functionality.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A predictive analytics system comprising:
a plurality of datasets received from a corresponding plurality of data sources, wherein at least one of the plurality of stored datasets includes first sensor data derived from direct observation of activity within an environment, and wherein the plurality of datasets is selected from the group consisting of agricultural, fishing, mining, lumber harvesting, environmental, and ecological datasets;
a data preparation module, including a processing device, configured to assign metadata to the datasets; and at least one of the following:
(a) a predictive analytics module, including a processing device, configured to train first and second machine learning models using the datasets as a source of predictor variables based on the assigned metadata for each of the machine learning models, and to use historical information regarding a metric of economic activity as a target variable, wherein the first and second machine learning models differ in at least one of machine learning model type and assigned metadata; and
(b) a hypothesis generating and testing system (HGTS) that trains the first and second machine learning models, selects the predictor variables for the machine learning models, and determines the leading indicator using the assigned metadata for the machine learning models; the HGTS includes an analytics engine configured to perform one or more of the following: assign first and second statistical metrics to the first and second machine learning models; store the assigned metadata, the first machine learning model, and the predictor variables in a primary database in response to determining that the statistical metric assigned to the first machine learning model meets a predetermined level; and store the assigned metadata, the second machine learning model, and the predictor variables in a second, probationary database in response to determining that the second machine learning model exhibits a statistical metric that does not meet a predetermined level; and select between the first and second machine learning models based on their respective statistical metric.

2. The predictive analytics system of claim 1, further comprising a publishing module configured to provide, to one or more subscribers, selected model information and output data including a leading indicator of the target variable based on the selected machine learning model and contemporaneous information received from at least one of the data sources.

3. The predictive analytics system of claim 1, wherein the set of agricultural attributes includes at least one of: (1) farmland or ranchland data, (2) crop turning, planting, weeding, fertilizing, watering, maintenance, harvesting, transportation, processing data, (3) soil, crop, or environmental data that can be collected from a plurality of sensing devices from in the ground, at ground level, aerial or satellite image data, (3) analytics information that can be inferred to represent health or yield of crops, orchards, land, livestock, ranches or other harvestable goods, (4) connections or correlations to other datasets that have associated information about an identified plot of land, region, or collective of farms, orchards, or ranches, and the weather events, weather trends, adjacent events or development information that could impact crop or harvest quantity or quality, and (5) connections or correlations to other datasets that provide regulatory, compliance, permitting data.

4. The predictive analytics system of claim 3, wherein the agricultural attributes include information associated with the observed behaviors, activity or movement within individuals farms or parcels of land and groups of farms or collective regions of land in the environment.

5. The predictive analytics system of claim 4, wherein the agricultural attributes include at least one of: area of land monitored, type or breed of crop, method of crop planting, maintenance, harvesting, and type or kind of equipment used.

6. The predictive analytics system of claim 1, wherein the set of fishing or aquaculture attributes includes (1) fresh water or sea water fishing, hatcheries, fish, shellfish, crustacean, or mammal farm area data, (2) harvesting, farming, maintenance, harvesting, transportation, processing data, (3) fresh or sea water or environmental data that can be collected from a plurality of sensing devices from in the water, at water level from the water body or adjacent land area, aerial or satellite image data, (3) analytics information that can be inferred to represent health of the environment or health of the animals, yield of fish farming, netting, trapping activity, (4) connections or correlations to other datasets that have associated information about an identified area of water, region, or collective of fish farms, harvesting or netting areas, and the weather events, weather trends, adjacent events or development information that could impact fish harvest quantity or quality, and (5) connections or correlations to other datasets that provide regulatory, compliance or permitting data.

7. The predictive analytics system of claim 6, wherein the fishing or aquacultural attributes includes information associated with the observed behaviors, activity or movement within individuals farms or vessels or areas within a body of water and groups of areas, groups of farms or collective regions of water in the environment.

8. The predictive analytics system of claim 6, wherein the fishing or aquacultural attributes includes at least one of: area of water monitored, type or breed of fish, shellfish, crustacean, or mammal; farming, maintenance, harvesting, methods; and type, kind, model, origin of the fishing vessel, boat, troller, or other harvesting and processing equipment used.

9. The predictive analytics system of claim 1, wherein the set of mining, lumber harvesting, land development, road building or construction attributes includes (1) open surface or underground or under ocean mining area data, (2) earth moving, leveling, maintenance, redirecting of water bodies, forested areas, rezoning, transportation, construction or material processing data, (3) forest, marshland, prairie, fresh or sea water or other environmental data that can be collected from a plurality of sensing devices from in the water, at water level from the water body or adjacent land area, at soil or land level, aerial or satellite image data, (4) analytics information that can be inferred to represent health of the environment or health of the forest in the lumber harvesting area, health of the land in or adjacent to the activity, (5) connections or correlations to other datasets that have associated information about an identified area of water, land, region, or collective of forests, mines, development areas, and the weather events, weather trends, forest fires, adjacent events or development information that could impact mining, lumber harvest, development quantity or quality, and (6) connections or correlations to other datasets that provide regulatory, compliance or permitting data.

10. The predictive analytics system of claim 9, wherein the mining, lumber harvesting, construction or land development attributes includes information associated with the observed behaviors, activity or movement within individual people, machines, businesses, or vessels or areas within an area or groups of areas, groups of mines, forests, developments or collective regions in the environment.

11. The predictive analytics system of claim 9, wherein the mining or lumber harvesting includes at least one of: area monitored, type or lumber, plant matter, soil, earth, material being harvested or mined; mining, maintenance, harvesting methods; and type, kind, model, origin of the harvesting, mining, transportation and processing equipment used. This data may include the visual appearance of individual machines, equipment, vessels or groups in the environment.

12. The predictive analytics system of claim 1, wherein the set of attributes is correlated to location services associated with the individuals, machines, vessels engaging in transportation, harvesting, mining, farming, fishing, earth-moving or any other activity in the environment which may also include identifying characteristics of the individuals, machines, equipment, vessels.

13. The predictive analytics system of claim 1, wherein the datasets include a temporal sequence of images selected from the group consisting of aerial images of fishing, mining, harvesting, development areas, construction areas, ecological regions, wherein the ecological regions comprise forests, prairies, marshes, water sources, tributaries, rivers, water bodies, and irrigation systems.

14. The predictive analytics system of claim 1, wherein the statistical metric is based on compiling and rank-ordering data correlations for the first and second machine learning models and determining statistical significance of the data correlations.

15. The predictive analytics system of claim 1, wherein the models are used to track historical information of individual or collective farms, fishing regions, lumber harvesting regions, areas of mining, development or construction activity, water bodies, tributaries, water sources or any other region of interest in a plurality of environments and to predict at least one of the reactions, behaviors, and business, environmental or ecological outcomes of a set or subset of the activities.

16. A method for performing predictive analytics comprising:
receiving a plurality of datasets from a corresponding plurality of data sources, wherein at least one of the plurality of stored datasets includes first sensor data derived from direct observation of activity within an environment, and wherein the plurality of datasets is selected from the group consisting of agricultural, fishing, mining, lumber harvesting, environmental, and ecological datasets;
using a data preparation module, including a processing device, to assign metadata to the datasets; and
performing at least one of the following:
(a) training, via a predictive analytics module including a processing device, first and second machine learning models using the datasets as a source of predictor variables based on the assigned metadata for each of the machine learning models, and to use historical information regarding a metric of economic activity as a target variable, wherein the first and second machine learning models differ in at least one of machine learning model type and assigned metadata; and
(b) via a hypothesis generating and testing system (HGTS), training first and second machine learning models, selecting the predictor variables for the machine learning models, and determines the leading indicator using the assigned metadata for the machine learning models; the HGTS including an analytics engine configured to: assign first and second statistical metrics to the first and second machine learning models; store the assigned metadata, the first machine learning model, and the predictor variables in a primary database in response to determining that the statistical metric assigned to the first machine learning model meets a predetermined level; and store the assigned metadata, the second machine learning model, and the predictor variables in a second, probationary database in response to determining that the second machine learning model exhibits a statistical metric does not meet a predetermined level; and select between the first and second machine learning models based on their respective statistical metric.

17. The method of claim 16, further comprising a publishing module configured to provide, to one or more subscribers, selected model information and output data including a leading indicator of the target variable based on the selected machine learning model and contemporaneous information received from at least one of the data sources.
